(19) United States
(12) Patent Application Publication
(10) Pub. No.: US 2006/0196155 A1
(43) Pub. Date: Sep. 7, 2006

(54) Crankcase exhaust contaminant removing device

(76) Inventors: Edward O. Rousar, Dalton Gardens, ID (US); Daniel Thomas Stafford, Hayden Lake, ID (US); Earl Tom Stetson, Heron, MT (US)

Correspondence Address: DEAN A. CRAINE, SUITE 140, 400 - 112TH AVENUE NE, BELLEVUE, WA, 98004, US

(21) Appl. No.: 11/073,346

(22) Filed: Mar. 4, 2005

(51) Int. Cl. B01D 46/04

(52) U.S. Cl. 55/428

(57) ABSTRACT

An improved crankcase exhaust contaminant removing device designed to reduce the contaminants returned from the PCV valve to the intake manifold. The device includes a main body that houses a smaller grate body. Longitudinally aligned and mounted on the inside surface of the main body is a feed tube that connects at its opposite ends to the exhaust line that extends between the PCV valve and the inlet manifold. The grate body is filled with a plurality of spherical beads and is divided into front and rear chambers by a rigid stop plate. Formed on the feed tube is an elongated opening that is closed off at its mid-line axis by the upper section of the stop plate. The feed tube partially extends into the grate body thereby placing the internal inlet and outlet openings on the feed tube inside the grate body. Because the stop plate extends downward into the grate body it acts as a barrier that forces exhaust gas to flow into the central regions of the two chambers and condenses on the beads. A collection space is created between the grate body and main body in which heavy hydrocarbons and sludge collect. A drain port is connected to the collection space that removes the waste material from the device.

### BACKGROUND OF THE INVENTION

1. Field of the Invention

The invention disclosed herein pertains to devices used to control crankcase emissions for internal combustion engines, and more particularly to such devices that separate solid and liquid waste matter from crankcase exhaust emissions.

2. Description of the Related Art

Devices used to removing contaminants from crankcase exhaust are found in the prior art. For example, U.S. Pat. No. 4,370,971, discloses a device used to collect and remove heavy, non-combustible, blow-by hydrocarbons and sludge from the exhaust line that connects the PCV valve to the intake manifold.

The blow-by gases, heavy hydrocarbons and sludge in the exhaust line must flow freely between the PCV valve and the intake manifold or between the crankcase exhaust port and the PCV valve to prevent exhaust back pressure in the engine. It is postulated that excessive exhaust back pressure is a major cause of ruptured engine seals and other types of engine damage.

Disclosed herein is an improved crankcase exhaust contaminant removing device specifically designed not to clog and to remove contaminants and allow the free flow of crankcase exhaust between the PCV valve and the intake manifold or the crankcase exhaust port and the PCV valve.

### SUMMARY OF THE INVENTION

The above object and other objects that may become apparent are met by the improved crankcase exhaust contaminants removing device disclosed herein that connects in the exhaust line that extends between a standard PCV valve and the inlet port on the intake manifold or between the crankcase exhaust port and the PCV valve. The device includes a closed main body that includes a feed tube that connects at one end to the segment exhaust line that connects to the PCV valve. The opposite end of the feed tube connects to the segment of the exhaust line that connects to the inlet port on the engine's intake manifold. In the preferred embodiment, the main body is a cylindrical structure with a longitudinally aligned feed tube securely attached to the inside surface of main body's sidewall. The opposite ends of the feed tube extend perpendicularly in opposite directions from the main body's opposite flat end surfaces.

Located inside the main body is a longitudinally and coaxially aligned grate body that is completely or substantially filled with a plurality of spherical beads. The grate body includes a cylindrical sidewall made of mesh material with sufficiently small meshing openings that hold the spherical beads inside the grate body. The grate body is sufficient in diameter so that the lower section of the feed tube partially extends into the grate body. The grate body is smaller in diameter then the main body thereby creating a surrounding collection space between the grate body and the main body for collecting heavy hydrocarbons and sludge that drips downward from the grate body and onto the inside surface of the main body. Formed on the sidewall of the main body opposite the feed tube is a perpendicular aligned drain port through which heavy hydrocarbons and sludge that collects in the collection space may be removed and deposited into a waste collection container.

Formed on the feed tube's medial surface is an elongated slot that terminates inside the grate body. A short section of mesh is placed over the elongated slot to prevent the spherical beads located inside the grate body from entering the feed tube and being dislodged. Located along the transverse, mid-line axis of the feed tube and bisecting the elongated slot is a stop plate that divides the main body into two chambers. The upper section of the stop plate extends into and closes off the feed tube thereby forcing exhaust gas delivered to one end of the feed to flow through the elongated slot and into the grate body. The perimeter edge of the stop plate extends into the grate body at or near that grates body's mid-line axis. During use, the stop plate acts as a barrier that forces exhaust gas to flow around the perimeter edge into the central region of the grate body during operation, thereby greatly increasing the amount of contact with the spherical beads.

As stated above, during use the device is connected between the two segments of exhaust lines that extend from the PCV valve and the intake manifold or between the crankcase exhaust port and the PCV valve. The device is aligned and rotated so that the opposite ends of the feed tube are longitudinally aligned with the two ends and the grate body is positioned below the feed tube. When the engine is operated, pressurized blow-by gases leave the PCV valve and flow into the inlet port on the feed tube. When the exhaust gases enter the inlet port, they first flow through the one-half opening on the elongated slot adjacent to the first chamber. Because the stop plate closes off the feed tube and extends into the grate body, the exhaust gases that enter the first chamber must flow around the perimeter edge of the stop plate before entering the second chamber. As the exhaust gases contacts the spherical beads, the heavy hydrocarbons and sludge carried in the exhaust gases are deposited thereon. When a sufficient quantity is deposited, it eventually falls via gravity forces into the collection space. Once deposited into the collection space, the heavy hydrocarbons and sludge then flow towards the drain port and are eventually discharged into a collection container.

The above described device greatly improves the removal of heavy hydrocarbons and sludge from the exhaust gases without creating any back pressure that may damage the engine. Back pressure is eliminated by using a feed pipe with the inlet and outlet ports, having the same diameter as the adjoining segments of exhaust lines that eventually lead to a relatively large main body when the heavy hydrocarbons and sludge may be separated from the exhaust gas.

### DESCRIPTION OF THE DRAWINGS

FIG. 1 is a perspective view of an improved crankcase exhaust contaminant removing device.

FIG. 2 is a top perspective view of the device partially dissembled showing the relative positions of the feed tube, the two end plates, and the four spacer fins.

FIG. 3 is a bottom perspective view of the device similar to the view shown in FIG. 2.

FIG. 4 is a sectional side elevation view taken along line 4-4 in FIG. 1.

FIG. 5. is a sectional end elevation view taken along line 5-5 in FIG. 4.

FIG. 6 is a bottom plan showing the elongated slot formed in the feed tube with the main body and grate body removed for greater clarity.

FIG. 7 is a side elevational view of a second embodiment of the invention with two downward extending plates attached to the side edges of the elongated slot to direct the exhaust gases into the center region of the grate body.

### DESCRIPTION OF THE PREFERRED EMBODIMENT(S)

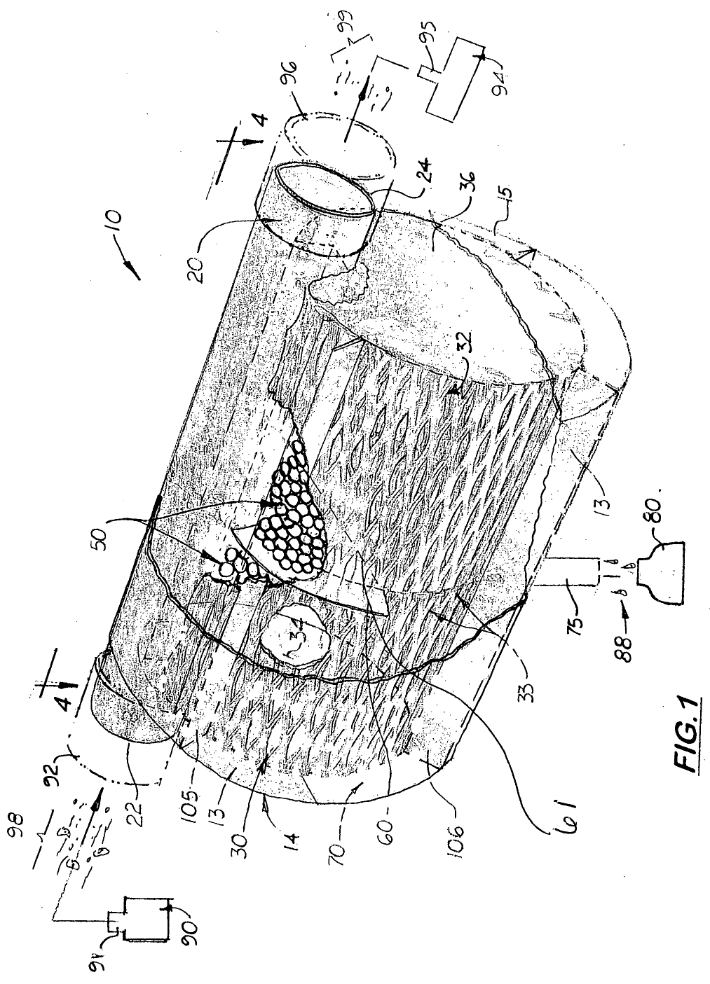

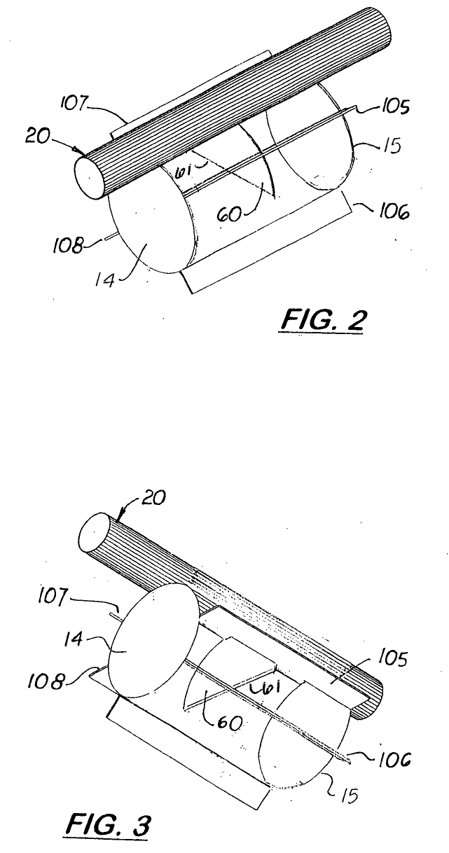

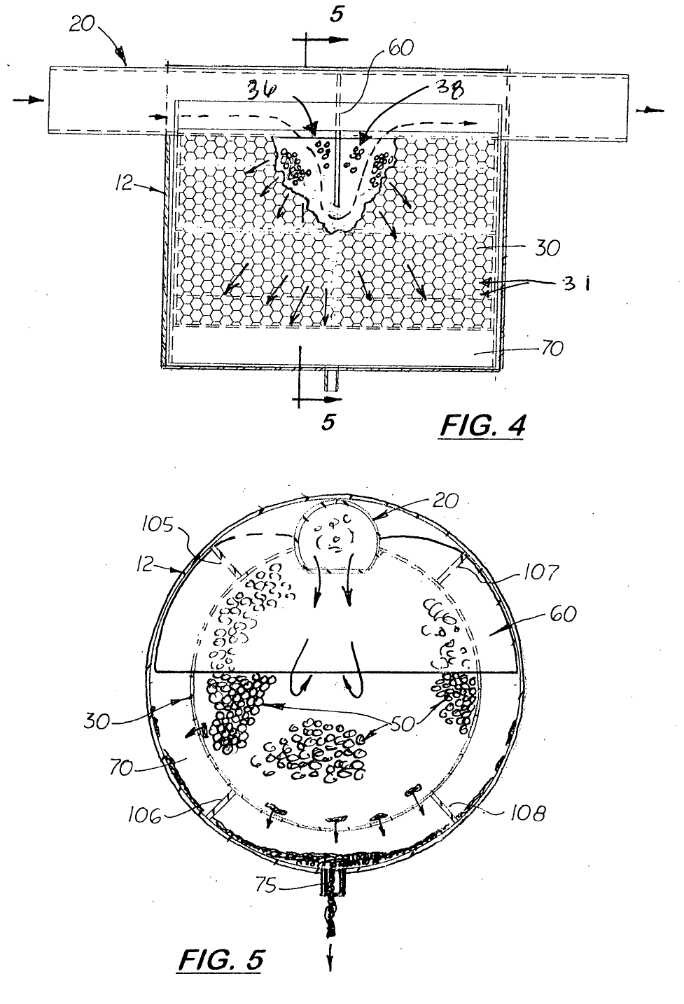

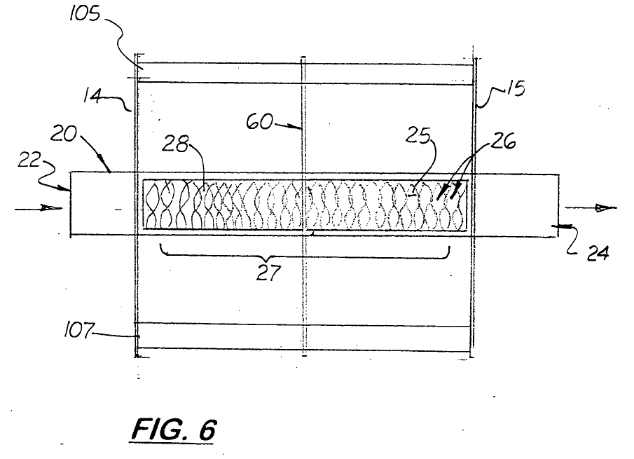

There is shown in the accompanying FIGS. 1-7, an improved crankcase exhaust contaminant removing device, generally referenced as 10, designed to remove heavy hydrocarbons and sludge 88 from the exhaust 98 that travels between the outlet port 91 on a standard PCV valve 90 and the inlet port 95 on the intake manifold 94. The device 10 is specifically designed to easily and quickly remove heavy hydrocarbons and sludge 88 from the exhaust gas 98 without impeding the flow of exhaust gas 98 from the engine.

Referring to FIG. 1, the device 10 includes an enclosed main body 12 that includes a cylindrical outer shell 13 and two opposite flat end plates 14, 15. Located along the inside surface of the outer shell 13 is feed tube 20. The inlet opening 22 of the feed tube 20 connects to the distal end of the exhaust line segment 92 that connects to the outlet port 91 on the PCV valve 90. The opposite outlet port 24 connects to the distal end of a second exhaust line segment 96 that connects to the inlet port 95 on the engine's intake manifold 94. The inlet and outlet openings 22, 24 of the feed tube 20 extend perpendicularly from the opposite end plates 14, 15, respectfully, of the main body 12.

Located inside the main body 12 is a longitudinally aligned grate body 30 that is completely or substantially filled with a plurality of spherical beads 50. The grate body 30 is a cylindrical structure with an outer mesh cover 32 connected to two flat end surfaces 34, 36. Formed on the mesh cover 32 is a plurality of mesh openings 33. In the embodiment, shown in the accompanying Figs., the end surfaces 34, 36 are plates. It should be understood however, that surfaces 34, 36 may also be made of mesh material similar to the mesh cover 32. The grate body 30 is coaxially aligned inside the main body 20 and securely connected to the sides of the feed tube 20.

As shown in FIG. 5, the longitudinal axis of the grate body 30 is longitudinally aligned within the main body 12. The grate body 30 is smaller in diameter than the main body 12 and coaxially aligned therein thereby creating a collection space 70 for heavy hydrocarbons and sludge 88 that collect on the spherical beads 50 and eventually drips downward from the grate body 30. Formed on the lower surface of the main body 12 opposite the feed tube 20 is a perpendicularly aligned drain port 75 through which the heavy hydrocarbons and sludge 88 may flow and collect in a waste collection container, generally designated as 80 in FIG. 1.

As shown in FIG. 5, the feed tube 20 partially extends downward a short distance into the grate body 30 thereby creating a collection space 70 discussed further below. Formed on the feed tube's medial surface 21 is an elongated slot 27 that allows exhaust gas to enter and exit the grate body 30. A short section of mesh plate 25 with a plurality of mesh openings 26. The mesh openings 26, 31 on the mesh plate 25 and grate body 30, respectfully, are sufficiently small to prevent the spherical beads 50 located in the grate body 30 from entering the feed tube 20 and being dislodged or unpacked from the device 10.

Located along the mid-line axis of the main body 12 and the feed tube 20 is a rigid stop plate 60. The stop plate 60 is transversely aligned inside the main body 12 and extends into the grate body 30 to partially divide the grate body 30 into two chambers, designated 36, 38. In the preferred embodiment, the stop plate 60 includes an upper curved perimeter edge and a flat, lower edge. The outer perimeter edge 61 of the stop plate 60 is curved and the sufficient in diameter to substantially extend across the main body 12 to prevent the flow of exhaust between chambers 36, 38 through the collection space 70. The lower edge 62 of the stop plate 60 extends transversely near or at the main body's transverse mid line axis. During use, the stop plate 60 acts as a directional barrier so that the exhaust gas 98 that enters the first chamber 36 must flow into the center region of the first chamber 36 and not directly into the collection space 70 located around the grate body 30.

The device 10 may be manufactured in different sizes and shapes. In the embodiment shown in the accompanying Figs, the main body 12 measures approximately 6 inches in length and 5 inches in diameter. The feed tube 20 measures approximately 11 inches in length and 1.25 inches in diameter. The spherical beads 50 are made of plastic resin or glass and are approximately ¼ inch in diameter. The grate or mesh openings 26, 31 on the mesh plate 25 and grate body 30 are approximately ⅛ to 3/32 inches in width. The main body 12, the feed tube 20, the grate body 30 and the stop plate 60 are made of 18 to 20 gauge steel or aluminum plate material and are welded or adhesively attached at their adjoining edges or surfaces.

As shown in FIG. 7, two optional, downward extending plates 110, 115 may be attached to the side longitudinal edges of the elongated slot to direct the flow of exhaust gas 98 into the center region of the first and second chambers. In the preferred embodiment, the two plates extended the entire length of the elongated slot 27. It should be understood however, that the two side plates 110, 115 may be used only on the portion of the elongated slot 27 located inside the first chamber 36 so that exhaust gas 98 is deposited centrally in the first chamber 36. The mesh plate 25 is then attached between the distal edges of the two plates 110, 115 to prevent the spherical beads 60 from be dislodged into the feed pipe 20.

As shown in the Figs, optional spacer fins 105, 106, 107, 108 are longitudinally and radially aligned and attached to the outer surface of the grate body 30. The spacer fins 105 are used to coaxially align and hold the grate body 30 inside the main body 12. In the embodiment shown in the Figs, there are two pairs of spacer fins 105, 106 and 107, 108 located on opposite sides of the grate body 30. The spacer fins 105, 106, 107, 108 are approximately the same length as the grate body 30 and are approximately ½ inch wide. I

During use, the device 10 is connected between the two sections of exhaust lines 92, 96 that extend from the PCV valve 90 and from the intake manifold 94, respectfully. The ends of the sections 92, 96 are forced over the inlet and outlet openings 22, 24 of the feed tube 20. Optional clips or connection bands (not shown) may be used to hold the ends of the ends of the segments exhaust lines 92, 96 on the feed tube 20. The device 10 is rotated over the ends of the exhaust tubes 92, 96 so that the main body 12 is positioned below the feed tube 20. When the engine is operated, the blow-by gases 98 leave the PCV valve 90 and enter the device's inlet opening 22. When the gases 98 enter the inlet opening 22 they then flow through one half of the elongated slot 28 and into the first chamber 36 inside the grate body 30. Because the feed tube 20 partially extends into the grate body 30, the exhaust gases 98, flow inward toward the center region and around the distal edge 61 of the stop plate 60 in order to flow into the second chamber 38. When the exhaust gases 98 contact the spherical beads 50, the heavy hydrocarbons and sludge 88 collect thereon, and eventually flow via gravity forces into the collection space 70. Once deposited into the collection space 70, the heavy hydrocarbons and sludge 88 then flow into the drain port 75 and eventually into a collection container 80. The “clean” exhaust gas 99 then exits the device 10 through the outlet opening. 24.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

We claim:

1. A crankcase exhaust contaminant removing device, comprising:
a. a hollow main body;
b. a feed tube longitudinally aligned inside said main body, said feed tube including a first and second exhaust openings longitudinally aligned thereon, said first and second exhaust openings being covered with mesh material;
c. a grate body longitudinally aligned inside said main body, said grate body extending at least partially around said feed tube so that said first and second exhaust openings are aligned inside said grate body, said grate body including a plurality of mesh openings formed thereon, said grate body being smaller in diameter than said main body thereby creating a collection space between said main body and said grate body;
d. a transversely aligned stop plate, said stop plate extending through said feed tube thereby creating an inlet opening and an outlet opening on said feed plate, said stop plate being sufficient in width and length to extend into said grate body so that exhaust gas that enters said grate body flows through said inlet port and must travel around the lower edge of said stop plate before flowing into said outlet opening;
e. a plurality of spherical beads located inside said grate body, said beads being sufficiently large so that they do not pass through said mesh openings formed on said grate body nor said mesh plate disposed over said exhaust openings; and,
f. at least one drain port formed on said main body.

2. The crankcase exhaust contaminant removing device, as recited in claim 1, further including at least one spacer fin located between said main body and said grate body.

3. The crankcase exhaust contaminant removing device, as recited in claim 1, wherein said main body is cylindrical.

4. The crankcase exhaust contaminant removing device, as recited in claim 3, wherein said grate body is cylindrical and smaller in diameter than said main body.

5. The crankcase exhaust contaminant removing device, as recited in claim 4, wherein said elongated slot is located inside said grate body.

6. The crankcase exhaust contaminant removing device, as recited in claim 5, further including two downward extending plates disposed around said elongated slot thereby directing the flow of exhaust gas into the center region of said grate body.

7. The crankcase exhaust contaminant removing device, as recited in claim 1, further including a two downward extending plates disposed around said elongated slot thereby directing the flow of exhaust gas into the center region of said grate body.

8. The crankcase exhaust contaminant removing device, as recited in claim 1, wherein said beads are spherical.
